(19) United States
(12) Patent Application Publication
(10) Pub. No.: US 2017/0198788 A1
(43) Pub. Date: Jul. 13, 2017

(54) SPRING COMPRESSOR FOR AN AIRGUN

(71) Applicant: Thomas Gore, Pinckney, MI (US)

(72) Inventor: Thomas Gore, Pinckney, MI (US)

(21) Appl. No.: 14/990,437

(22) Filed: Jan. 7, 2016

(51) Int. Cl. F16H 25/20; F41B 11/646

(52) U.S. Cl. CPC F16H 25/20; F41B 11/646; F16H 2025/2037

(57) ABSTRACT

A spring compressor for compressing a power spring of an air gun within a compression tube of the air gun includes a beam that extends along a longitudinal axis between a first end and a second end. The beam includes a dovetail shaped slot that extends along the beam, for engaging an accessory rail on the air gun. The beam includes a clamp portion that is disposed adjacent the first end of the beam. The clamp portion is integrally formed with the main structure of the beam. The clamp portion is operable to directly engage the accessory rail on the air gun in clamping engagement. A compressor includes a rod in threaded engagement with a post, which is mounted adjacent the second end of the beam. Rotation of the threaded rod relative to the post moves the threaded rod axially along the longitudinal axis relative to the beam.

### TECHNICAL FIELD

The disclosure generally relates to a spring compressor for compressing and/or decompressing a power spring within a compression tube of an air gun.

### BACKGROUND

An air gun is a rifle, pistol, etc., which utilizes a compressed gas to fire a projectile. Air guns may be powered by, for example, a coil spring assembly or a gas spring assembly, hereinafter referred to generally as a power spring.

Air guns typically include a compression tube that defines a compression chamber. The power spring is positioned within the compression chamber. A trigger assembly is positioned within and adjacent a rearward end of the compression chamber, adjacent the power spring, and is securely attached to the compression tube. During assembly of the air gun, the power spring must be compressed to a certain degree to enable the trigger assembly to properly seat within the rearward end of the compression chamber, so that it may then be attached to the compression tube. During disassembly, when the trigger assembly is being disconnected from the compression tube, the trigger assembly and the power spring must be restrained to prevent rapid expansion of the power spring and ejection of the power spring and/or trigger assembly from the compression tube. A spring compressor may be used to bias the trigger assembly against the power spring to compress the power spring during assembly, and restrain the power spring and the trigger assembly during disassembly.

### SUMMARY

A spring compressor is provided. The spring compressor includes a beam that extends along a longitudinal axis between a first end and a second end. The beam includes a clamp portion that is disposed adjacent the first end of the beam. The clamp portion is operable to directly engage an accessory rail on an air gun in clamping engagement. A compressor is attached to the beam adjacent the second end of the beam. The compressor is axially moveable along the longitudinal axis relative to the beam.

A spring compressor for compressing a power spring of an air gun is also provided. The spring compressor includes a beam that extends along a longitudinal axis, between a first end and a second end. The beam includes a clamp portion disposed adjacent the first end of the beam. The clamp portion is operable to directly engage an accessory rail on the air gun in clamping engagement. The clamp portion and the beam are integrally formed together from a singular structure. The beam defines a slot that extends along the longitudinal axis of the beam. The slot includes a dovetail mortise extending along the longitudinal axis of the beam, which corresponds to a dovetail tenon of the accessory rail of the air gun for interlocking engagement therebetween. The interlocking engagement between the slot and the accessory rail prevents lateral movement of the beam relative to the air gun in a direction transverse to the longitudinal axis. Additionally, the interlocking engagement between the slot and the accessory rail allows longitudinal movement of the beam relative to the air gun along the longitudinal axis. The beam includes a channel having a first portion extending from the first end of the beam axially along the longitudinal axis to an interior bend, and a second portion extending from the interior bend transverse relative to the longitudinal axis to a first longitudinal side surface of the beam. The clamp portion is bounded by the first portion and the second portion of the channel. The first portion of the channel separates the clamp portion from a second longitudinal side surface of the beam. A cross bore extends transverse to the longitudinal axis of the beam. The cross bore includes a first section extending through the clamp portion, and a second section extending through the second longitudinal side surface of the beam. The second section of the cross bore includes a thread form. A clamp screw extends through the first section of the cross bore and into threaded engagement with the thread form of the second section of the cross bore. The clamp screw is operable to bias the clamp portion towards the second longitudinal side surface of the beam to clamp the accessory rail of the air gun between the clamp portion and the second longitudinal side surface of the beam. A post extends from the beam in a direction substantially perpendicular to the longitudinal axis of the beam. The post defines a threaded bore extending along a bore axis, in a direction substantially parallel to the longitudinal axis of the beam. A threaded rod is disposed in threaded engagement with the threaded bore of the post. The threaded rod includes a contact end that is disposed between the post and the first end of the beam. Rotation of the threaded rod in a first rotational direction advances the contact end of the threaded rod toward the first end of the beam, and rotation of the threaded rod in a second rotational direction retracts the contact end of the threaded rod away from the first end of the beam.

Accordingly, the dovetail slot in the beam may be slid over the dovetail tenon of the accessory rail on an air gun, thereby allowing the spring compressor to be axially positioned relative to a rearward end of a compression tube of the air gun. Once properly positioned, the lock screw may be tightened to directly tighten the clamp portion of the beam against the accessory rail, thereby securing the spring compressor relative to the air gun. Since the accessory rail on an air gun is substantially aligned with a bore axis of the barrel, and the slot extends along the longitudinal axis of the beam, the interlocking engagement between the slot and the accessory rail automatically aligns the spring compressor along the bore axis of the air gun. The compressor may then be moved axially into and out of engagement with a trigger assembly to compress and/or decompress a power spring for assembly and disassembly of the air gun. The spring compressor is a simple, lightweight device that is easily handled and transported. The spring compressor may be used with any air gun that includes a standard accessory rail, regardless of the length of the air gun.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic exploded side view of an air gun, showing a compression tube, a power spring, and a trigger assembly.

FIG. 2 is a schematic side view of the air gun showing a spring compressor attached to the compression tube and biasing the trigger assembly against the power spring for assembly and/or disassembly.

FIG. 3 is a schematic perspective view of the spring compressor.

FIG. 4 is a schematic plan view of the spring compressor.

FIG. 5 is a schematic side view of the spring compressor.

FIG. 6 is a schematic end view of the spring compressor.

FIG. 7 is a schematic cross sectional view of the spring compressor attached to an accessory rail on the compression tube.

FIG. 8 is a schematic partial cross sectional view of an alternative embodiment of the spring compressor.

FIG. 9 is a schematic plan view of the alternative embodiment of the spring compressor shown in FIG. 8.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims.

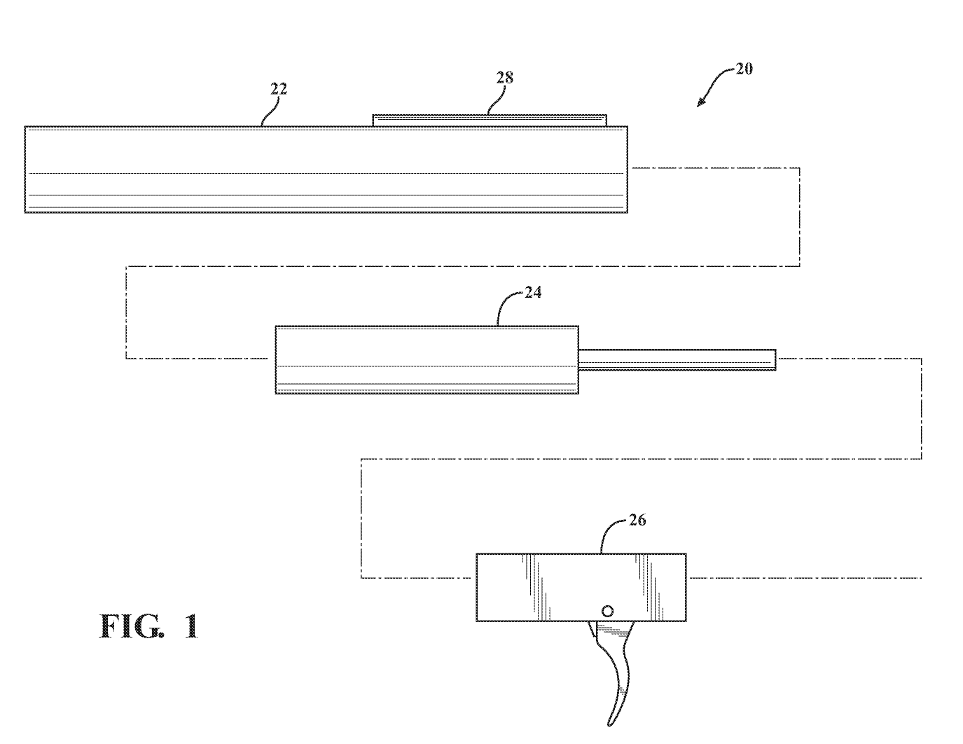

Referring to the Figures, wherein like numerals indicate like parts throughout the several views, components of an air gun 20 are generally shown in FIG. 1. Referring to FIG. 1, the air gun 20 includes a compression tube 22. The compression tube 22 is a generally hollow cylinder, which supports a power spring 24 and a trigger assembly 26. A barrel (not shown) is attached to the compression tube 22, and the compression tube 22 and barrel are supported by a stock (not shown). As shown, and as is typical of most air guns 20, the compression tube 22 includes an accessory rail 28 that is typically used for mounting a telescopic sight. The accessory rail 28 may be integrally formed with the compression tube 22, or may be a separate component fixedly attached to the compression tube 22, with multiple fasteners. The accessory rail 28 includes a standardized dovetailed tenon shape and/or configuration that is common throughout the firearms industry.

The power spring 24 may include, but is not limited to, a coil spring assembly or a gas spring assembly. The power spring 24 assembly is compressed to store energy. Upon being released by actuation of the trigger assembly 26, the power spring 24 moves a piston to compress a gas within a compression chamber, thereby propelling a projectile through the barrel as is known in the art. The trigger assembly 26 is fixedly attached and/or secured to the compression tube 22, within an interior region of the compression tube 22. The trigger assembly 26 may be attached to the compression tube 22 in any suitable manner, such as with a fastener, e.g., a pin or screw, that passes through a wall of the compression tube 22 and the trigger assembly 26. The power spring 24 is disposed within the interior of the compression tube 22, and is secured in place by the trigger assembly 26, which abuts the power spring 24. In order to properly position the trigger assembly 26 within the compression tube 22 and attach the trigger assembly 26 to the compression tube 22, the power spring 24 must be partially compressed. Additionally, in order to remove the trigger assembly 26 and/or the power spring 24, the trigger assembly 26 must be restrained while the fasteners securing the trigger assembly 26 to the compression tube 22 are removed, in order to prevent rapid expansion of the power spring 24, which may rapidly eject the trigger assembly 26 and/or the power spring 24 from within the interior of the compression tube 22.

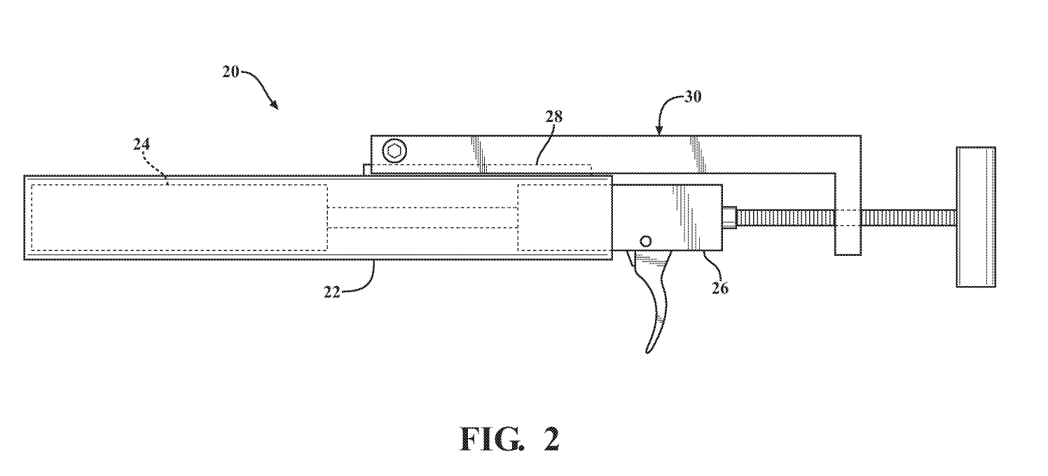

Referring to FIG. 2, in order to compress and/or restrain the power spring 24 during assembly and/or disassembly, a spring compressor 30 may be attached to the compression tube 22 and used to compress the power spring 24, or release compression of the power spring 24 in a controlled manner. The spring compressor 30 is attached to the compression tube 22, and biases the trigger assembly 26 and the power spring 24 against the compression tube 22 to compress and/or controllably release compression of the power spring 24.

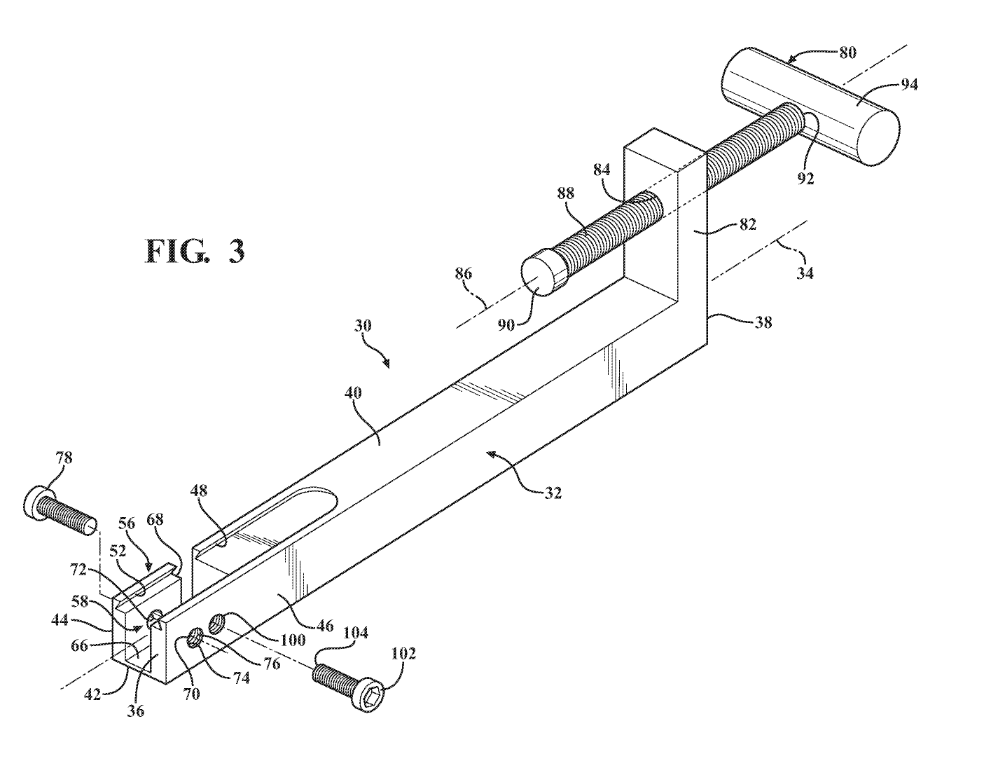

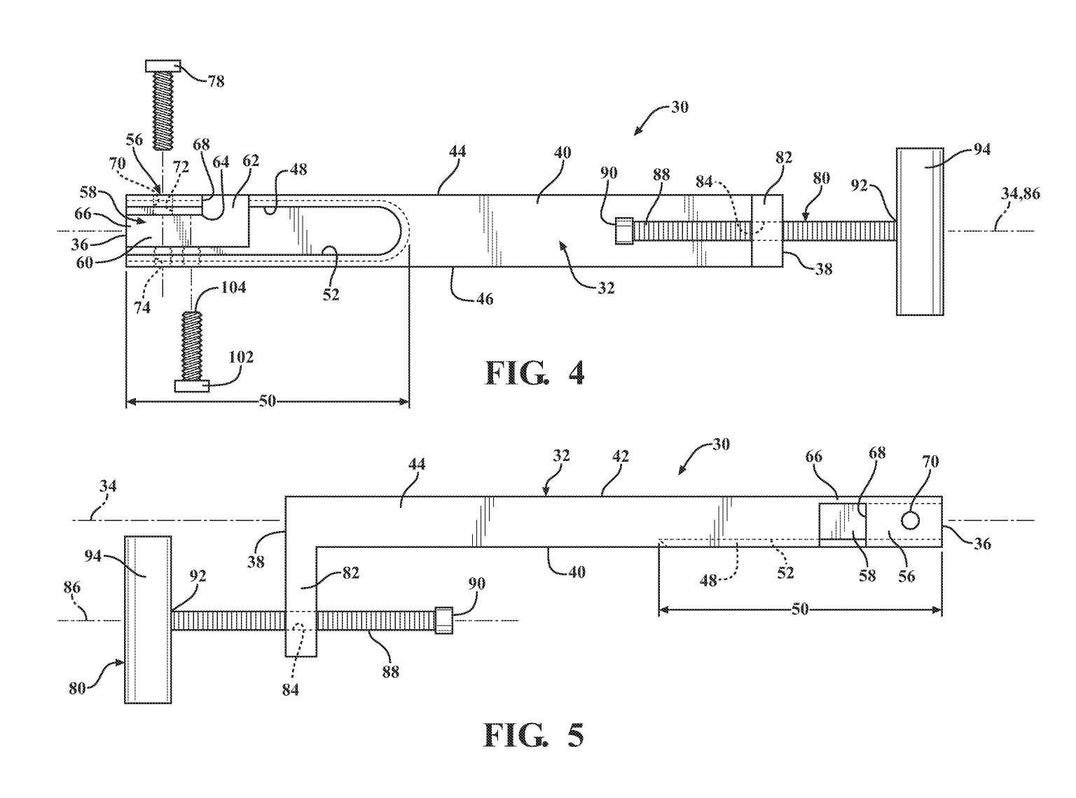

Referring to FIGS. 3-7, an exemplary embodiment of the spring compressor 30 is generally shown. Referring to FIGS. 4 and 5, the spring compressor 30 includes a beam 32 that extends along a longitudinal axis 34, between a first end 36 and a second end 38. Preferably, the beam 32 includes a cross section, taken perpendicular to the longitudinal axis 34 of the beam 32, which defines a non-circular cross sectional shape. However, in some embodiments, the cross sectional shape of the beam 32 perpendicular to the longitudinal axis 34 of the beam 32 may include a circular cross sectional shape. As shown in the exemplary embodiment, the cross sectional shape of the beam 32 perpendicular to the longitudinal axis 34 of the beam 32 is a rectangular shape. However, it should be appreciated that the cross sectional shape of the beam 32 may differ from the exemplary embodiment shown in the Figures and described herein.

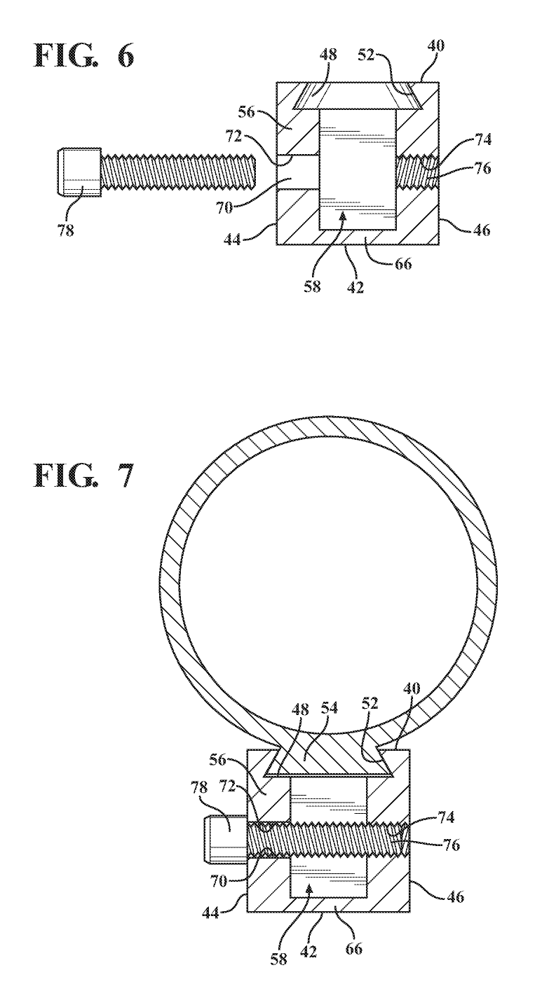

As shown in the Figures, the beam 32 includes an upper longitudinal surface 40, a lower longitudinal surface 42, a first longitudinal side surface 44, and a second longitudinal side surface 46, which all cooperate to define the generally rectangular cross sectional shape of the beam 32. Referring to FIG. 4, the beam 32 defines a slot 48 that extends along the longitudinal axis 34. Referring also to FIG. 6, the slot 48 is disposed adjacent the upper longitudinal surface 40 of the beam 32, and extends a slot distance 50 (shown in FIG. 4) from the first end 36 of the beam 32 toward the second end 38 of the beam 32, the slot distance 50 may include any desirable distance, but is preferably longer than a length of the standardized accessory rail 28 on the compression tube 22.

Referring to FIGS. 6 and 7, the slot 48 defines a shape corresponding to the accessory rail 28 on the compression tube 22 of the air gun 20. The slot 48 is sized and shaped to enable the slot 48 to slide over the accessory rail 28, in a direction parallel with the longitudinal axis 34 of the beam 32 to engage the accessory rail 28 in interlocking engagement therebetween. The interlocking engagement between the slot 48 and the accessory rail 28 prevents lateral movement of the beam 32 relative to the air gun 20 in a direction transverse to the longitudinal axis 34 of the beam 32, while allowing longitudinal movement of the beam 32 relative to the compression tube 22 of the air gun 20 along the longitudinal axis 34 of the beam 32.

As best shown in FIGS. 6 and 7, the slot 48 includes a dovetail configuration extending along the longitudinal axis 34 of the beam 32. More specifically, the slot 48 defines a cross section perpendicular to the longitudinal axis 34 of the beam 32 that defines a dovetail mortise 52. The cross sectional shape of the slot 48, i.e., the dovetail mortise 52, is extended along the longitudinal axis 34 to define the dovetail shaped slot 48. As best shown in FIG. 7, the accessory rail 28 defines a cross sectional perpendicular to the longitudinal axis 34 of the beam 32 that defines a dovetail tenon 54. The cross sectional shape of the accessory rail 28, i.e., the dovetail tenon 54, is extended along the longitudinal axis 34 to define the dovetail shaped accessory rail 28.

Referring to FIGS. 4 and 5, the beam 32 includes a clamp portion 56 that is disposed adjacent the first end 36 of the beam 32. The clamp portion 56 is operable to directly engage the accessory rail 28 on the compression tube 22 of the air gun 20 in clamping engagement, such as shown in FIG. 7. The clamp portion 56 is formed from the first longitudinal side surface 44, and may at least partially define the slot 48. The clamp portion 56 and the beam 32 are integrally formed together from a single piece of material, such as bar stock. Preferably, the beam 32, including the clamp portion 56, are formed from a metal material, such as steel or aluminum. However, it should be appreciated that the beam 32 may be formed from and include some other material that is rigid enough to provide the required stiffness needed while compressing the power spring 24.

Referring to FIG. 4, the beam 32 includes a channel 58 having a first portion 60 and a second portion 62. The first portion 60 of the channel 58 extends from the first end 36 of the beam 32, axially along the longitudinal axis 34 to an interior bend 64. The second portion 62 of the channel 58 extends from the interior bend 64, in a direction that is transverse relative to the longitudinal axis 34 of the beam 32, to the first longitudinal side surface 44 of the beam 32. The clamp portion 56 is bounded by the first portion 60 and the second portion 62 of the channel 58.

Referring to FIG. 6, the channel 58 defines and/or includes a bottom wall portion 66 of the beam 32, which is adjacent the lower longitudinal surface 42 of the beam 32. As noted above, the slot 48 is disposed adjacent the upper longitudinal surface 40 of the beam 32, which is opposite the bottom wall portion 66 of the beam 32. Accordingly, the bottom wall portion 66 is disposed on an opposite surface of the beam 32 relative to the slot 48 in the beam 32. The bottom wall portion 66 of the beam 32 extends between the clamp portion 56 and the second longitudinal side surface 46 of the beam 32. Accordingly, the first portion 60 of the channel 58 separates the clamp portion 56 from the second longitudinal side surface 46 of the beam 32.

As shown in FIG. 6, the clamp portion 56 extends from the bottom wall portion 66 to a distal edge 68 adjacent the upper longitudinal surface 40 of the beam 32. Accordingly, it is the bottom wall portion 66 of the beam 32 that connects the clamp portion 56 to the remainder of the beam 32. Because the clamp portion 56 is bounded by the first portion 60 and the second portion 62 of the channel 58 (best shown in FIG. 4), the clamp portion 56 may bend slightly about a joint at the intersection between the clamp portion 56 and the bottom wall portion 66 (shown in FIGS. 6 and 7), thereby allowing the clamp portion 56 to bend inward toward the second longitudinal side surface 46, opposite the clamp portion 56, such as shown in FIG. 7. Accordingly, it is the channel 58 formed into the beam 32 that enables the operation of the clamp portion 56.

Referring to FIGS. 6 and 7, the beam 32 includes a cross bore 70 that extends transverse to the longitudinal axis 34 of the beam 32. The cross bore 70 includes a first section 72 and a second section 74. The first section 72 of the cross bore 70 extends through the clamp portion 56. The second section 74 of the cross bore 70 extends through the second longitudinal side surface 46 of the beam 32, and includes and/or defines a thread form 76. A clamp screw 78 extends through the first section 72 of the cross bore 70, and into threaded engagement with the thread form 76 in the second section 74 of the cross bore 70. The clamp screw 78 is operable to draw the clamp portion 56 towards the second longitudinal side surface 46 of the beam 32 when tightened, to clamp the accessory rail 28 of the air gun 20 between the clamp portion 56 and the second longitudinal side surface 46 of the beam 32.

Referring to FIGS. 3 and 4, the beam 32 includes a second bore 100 that extends through the second longitudinal side surface 46 of the beam 32, transverse to the longitudinal axis 34, and includes and/or defines a thread form. A spreading screw 102 may be positioned within and in threaded engagement with the second bore 100. The spreading screw 102 may be advanced within the second bore 100 until an axial end 104 of the spreading screw contacts the clamp portion 56. Further advancement of the spreading screw 102 within the second bore 100 causes the spreading screw 102 to press against the clamp portion 56, and bias the clamp portion 56 away from the second longitudinal side surface 46, thereby spreading or increasing a width of the slot 48. In so doing, the slot 48, between the clam portion and the second longitudinal side surface 46, may be sized to accept a slightly larger accessory rail 28.

Referring to FIG. 2, a compressor 80 is attached to the beam 32 adjacent the second end 38 of the beam 32. The compressor 80 is axially moveable along the longitudinal axis 34 relative to the beam 32. The compressor 80 is used to contact and engage the trigger assembly 26, which in turn contacts and engages the power spring 24. With the spring compressor 30 clamped onto the accessory rail 28 of the compression tube 22 to secure the spring compressor 30 relative to the compression tube 22, moving the compressor 80 axially along the longitudinal axis 34 toward the first end 36 of the beam 32 compresses the power spring 24 and pushes the trigger assembly 26 further into the interior of the compression tube 22, to properly position the trigger assembly 26 within the interior of the compression tube 22 for attachment to the compression tube 22. With the spring compressor 30 clamped onto the accessory rail 28 of the compression tube 22 to secure the spring compressor 30 relative to the compression tube 22, moving the compressor 80 axially along the longitudinal axis 34 away from the first end 36 of the beam 32 slowly decompresses the power spring 24, allowing safe removal of the trigger assembly 26 and the power spring 24.

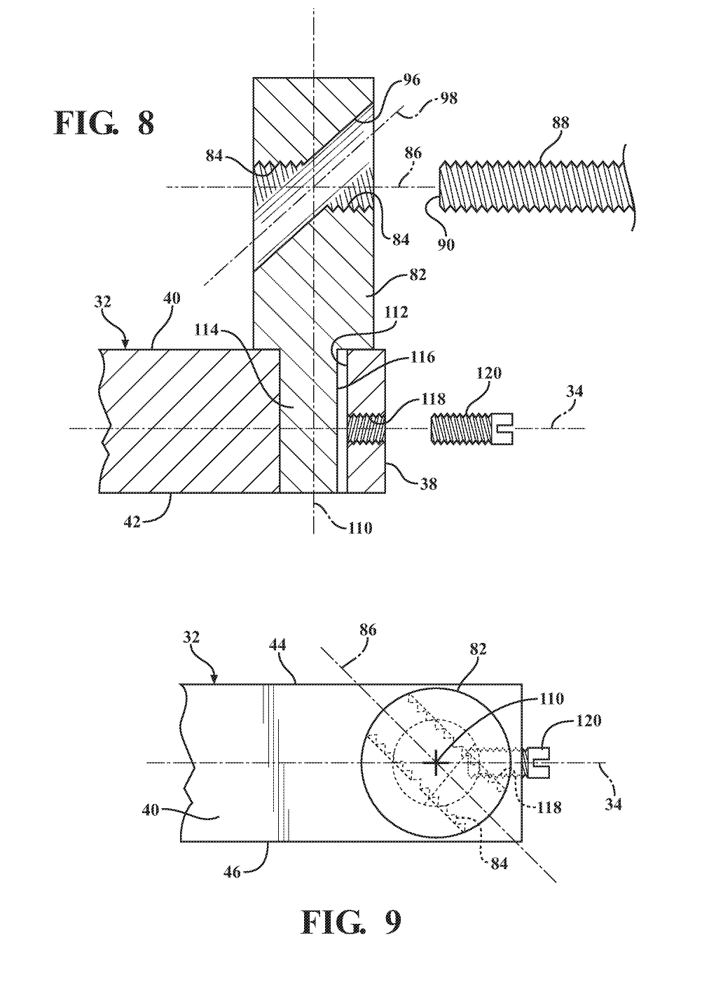

The compressor 80 may be configured in any manner capable of biasing against the trigger assembly 26 and moving axially along or parallel to the longitudinal axis 34 of the beam 32. As shown in the exemplary embodiment of the spring compressor 30 in FIGS. 3-7, the compressor 80 includes a post 82 attached to the beam 32 adjacent the second end 38 of the beam 32. Referring to FIG. 5, the post 82 extends outward from the upper longitudinal surface 40 of the beam 32, in a direction substantially perpendicular to the longitudinal axis 34 of the beam 32. The exemplary embodiment of the spring compressor 30 shown in FIGS. 3-7 include the post 82 being integrally formed with the beam 32 from the same, single piece of material. However, other embodiments of the compressor 80, such as shown in FIG. 8, may include the post 82 being separate from the beam 32.

Referring to FIGS. 4 and 5, the post 82 defines a threaded bore 84, which extends along a bore axis 86 in a direction substantially parallel to the longitudinal axis 34 of the beam 32. The bore axis 86 is generally parallel with and laterally offset from the longitudinal axis 34 of the beam 32. The compressor 80 includes a threaded rod 88 that is disposed in threaded engagement with the threaded bore 84 of the post 82. The threaded rod 88 includes a contact end 90 disposed between the post 82 and the first end 36 of the beam 32. Rotation of the threaded rod 88 in a first rotational direction, e.g., clockwise, advances the contact end 90 of the threaded rod 88 toward the first end 36 of the beam 32. Rotation of the threaded rod 88 in a second rotational direction, e.g., counterclockwise, retracts the contact end 90 of the threaded rod 88 away from the first end 36 of the beam 32. A second end 92 of the threaded rod 88 may include a handle 94, or some other device that enables easy application of torque to the threaded rod 88. For example, the second end 92 of the threaded rod 88 may be fitted with an attachment to receive a ratchet or a wrench. It should be appreciated that the compressor 80 described herein and shown in the Figures is merely an exemplary embodiment, and that the scope of the claims contemplates that other embodiments of the compressor 80 may be used to compress the power spring 24. Additionally, while the exemplary embodiment of the compressor 80 utilizes the mechanical advantage of the thread forms 76 between the threaded rod 88 and the threaded bore 84, alternative embodiments of the compressor 80 may include and use other types of mechanisms, such as but not limited to levers, electric linear actuators, pneumatic and/or hydraulic linear actuators, etc.

Referring to FIG. 8, the post 82 may include and/or define an angled bore 96 that extends along an intersection axis 98. The intersection axis 98 is angled relative to and intersects the bore axis 86 of the threaded bore 84. The angled bore 96 intersects the threaded bore 84. Accordingly, the overlapping sections between the angled bore 96 and the threaded bore 84 are voids that do not include any threads for engaging the threaded rod 88. This enables the threaded rod 88 to slide relative to the post 82, without rotation about the bore axis 86 relative to the post 82, when the threaded rod 88 is substantially aligned with the angled bore 96 along the intersection axis 98. This is because when the threaded rod 88 is aligned along the intersection axis 98, the threads on the threaded rod 88 are disengaged from the threads on the threaded bore 84, thereby allowing the threaded rod 88 to slide relative to the post 82 without rotation. The threaded rod 88 is disposed in threaded engagement with the threaded bore 84 when substantially aligned with the threaded bore 84 along the bore axis 86. Accordingly, tilting the threaded rod 88 to align it with the intersection axis 98 allows for quick adjustment of the threaded rod 88, whereafter the threaded rod 88 may be then aligned along the bore axis 86 to engage the threaded bore 84 in threaded engagement.

Referring to FIG. 8, an alternative embodiment of the spring compressor 30 is generally shown. As noted above, the post 82 of the compressor 80 is separate from the beam 32. The post 82 is rotatably supported by the beam 32 for rotation about a central post axis 110. The beam 32 defines an aperture 112, with a lower portion 114 of the post 82 received within the aperture 112. The lower portion 114 of the post 82 includes a planar section 116, which is parallel with and extends along the central post axis 110. The beam 32 includes a threaded angle adjustment bore 118 that extends from the second end 38 of the beam 32, axially along the longitudinal axis 34 of the beam 32, and into the aperture 112. A lock screw 120 is disposed in threaded engagement with the threaded angle adjustment bore 118. The lock screw 120 engages the lower portion 114 of the post 82 in abutting engagement. More specifically, the lock screw 120 contacts the planar section 116 on the post 82 to secure an angular position of the post 82 about the central post axis 110, relative to the beam 32. Referring to FIG. 9, rotation of the post 82 about the central post axis 110, relative to the beam 32, rotates the bore axis 86 relative to the longitudinal axis 34 of the beam 32. By angling the bore axis 86 relative to the longitudinal axis 34 of the beam 32, the contact end 90 of the compressor 80 may be positioned to engage a portion of the trigger assembly 26 that is slightly off-center, or positioned near an edge of the compression tube 22.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A spring compressor comprising:
a beam extending along a longitudinal axis between a first end and a second end;
wherein the beam includes a clamp portion disposed adjacent the first end of the beam, and operable to directly engage an accessory rail on an air gun in clamping engagement; and
a compressor attached to the beam adjacent the second end of the beam and axially moveable along the longitudinal axis relative to the beam.

2. The spring compressor set forth in claim 1 wherein the beam defines a slot extending along the longitudinal axis, with the slot defining a shape corresponding to the accessory rail of the air gun for interlocking engagement therebetween, wherein the interlocking engagement between the slot and the accessory rail prevents lateral movement of the beam relative to the air gun in a direction transverse to the longitudinal axis, and wherein the interlocking engagement between the slot and the accessory rail allows longitudinal movement of the beam relative to the air gun along the longitudinal axis.

3. The spring compressor set forth in claim 2 wherein the slot includes a dovetail configuration extending along the longitudinal axis of the beam.

4. The spring compressor set forth in claim 3 wherein the clamp portion at least partially defines the slot.

5. The spring compressor set forth in claim 2 wherein the clamp portion and the beam are integrally formed together.

6. The spring compressor set forth in claim 2 wherein the beam includes a channel having a first portion extending from the first end of the beam axially along the longitudinal axis to an interior bend, and a second portion extending from the interior bend transverse relative to the longitudinal axis to a first longitudinal side surface of the beam, wherein the clamp portion is bounded by the first portion and the second portion of the channel.

7. The spring compressor set forth in claim 6 wherein the first portion of the channel separates the clamp portion from a second longitudinal side surface of the beam.

8. The spring compressor set forth in claim 7 further comprising a cross bore extending transverse to the longitudinal axis of the beam, wherein the cross bore includes a first section extending through the clamp portion and a second section extending through the second longitudinal side surface of the beam.

9. The spring compressor set forth in claim 8 wherein the second section of the cross bore includes a thread form.

10. The spring compressor set forth in claim 9 further comprising a clamp screw extending through the first section of the cross bore and into threaded engagement with the second section of the cross bore, and operable to draw the clamp portion towards the second longitudinal side surface of the beam to clamp the accessory rail of the air gun between the clamp portion and the second longitudinal side surface of the beam.

11. The spring compressor set forth in claim 6 wherein the beam includes an upper longitudinal surface, and a lower longitudinal surface, and wherein the channel defines a bottom wall portion of the beam adjacent the lower longitudinal surface and extending between the clamp portion and a second longitudinal side surface of the beam, such that the clamp portion extends from the bottom wall portion to a distal edge adjacent the upper longitudinal surface of the beam.

12. The spring compressor set forth in claim 11 wherein the slot is disposed adjacent the upper longitudinal surface of the beam, opposite the bottom wall portion of the beam.

13. The spring compressor set forth in claim 1 wherein the compressor includes a post extending from an upper longitudinal surface of the beam in a direction substantially perpendicular to the longitudinal axis of the beam.

14. The spring compressor set forth in claim 13 wherein the post is integrally formed with the beam.

15. The spring compressor set forth in claim 13 wherein the post defines a threaded bore extending along a bore axis in a direction substantially parallel to the longitudinal axis of the beam.

16. The spring compressor set forth in claim 15 wherein the compressor includes a threaded rod disposed in threaded engagement with the threaded bore of the post, wherein the threaded rod includes a contact end disposed between the post and the first end of the beam, and wherein rotation of the threaded rod in a first rotational direction advances the contact end of the threaded rod toward the first end of the beam, and rotation of the threaded rod in a second rotational direction retracts the contact end of the threaded rod away from the first end of the beam.

17. The spring compressor set forth in claim 16 wherein the post defines an angled bore extending along an intersection axis that is angled relative to and intersects the bore axis of the threaded bore, such that the angled bore intersects the threaded bore so that the threaded rod may slide relative to the post without rotation when substantially aligned with the angled bore along the intersection axis, and the threaded rod is disposed in threaded engagement with the threaded bore when substantially aligned with the threaded bore along the bore axis.

18. The spring compressor set forth in claim 1 wherein a cross section of the beam perpendicular to the longitudinal axis of the beam defines a non-circular cross sectional shape.

19. The spring compressor set forth in claim 16 wherein the post is rotatably supported by the beam for rotation about a central post axis.

20. The spring compressor set forth in claim 19 wherein the beam defines an aperture, with a lower portion of the post received within the aperture.

21. The spring compressor set forth in claim 20 wherein the beam includes a threaded angle adjustment bore extending from the second end of the beam axially along the longitudinal axis of the beam and into the aperture.

22. The spring compressor set forth in claim 21 further comprising a lock screw in threaded engagement with the threaded angle adjustment bore and engaging the lower portion of the post in abutting engagement.

23. The spring compressor set forth in claim 22 wherein the lower portion of the post includes a planar section, with the lock screw contacting the planar section to secure an angular position of the post about the central post axis relative to the beam.

24. A spring compressor for compressing a power spring of an air gun, the spring compressor comprising:
a beam extending along a longitudinal axis between a first end and a second end;
wherein the beam includes a clamp portion disposed adjacent the first end of the beam, and operable to directly engage an accessory rail on the air gun in clamping engagement, with the clamp portion and the beam integrally formed together from a singular structure;
wherein the beam defines a slot extending along the longitudinal axis of the beam, with the slot including a dovetail mortise extending along the longitudinal axis of the beam and corresponding to a dovetail tenon of the accessory rail of the air gun for interlocking engagement therebetween, wherein the interlocking engagement between the slot and the accessory rail prevents lateral movement of the beam relative to the air gun in a direction transverse to the longitudinal axis, and wherein the interlocking engagement between the slot and the accessory rail allows longitudinal movement of the beam relative to the air gun along the longitudinal axis;
wherein the beam includes a channel having a first portion extending from the first end of the beam axially along the longitudinal axis to an interior bend, and a second portion extending from the interior bend transverse relative to the longitudinal axis to a first longitudinal side surface of the beam, wherein the clamp portion is bounded by the first portion and the second portion of the channel, with the first portion of the channel separating the clamp portion from a second longitudinal side surface of the beam;
a cross bore extending transverse to the longitudinal axis of the beam, wherein the cross bore includes a first section extending through the clamp portion and a second section extending through the second longitudinal side surface of the beam, with the second section of the cross bore including a thread form;
a clamp screw extending through the first section of the cross bore and into threaded engagement with the thread form of the second section of the cross bore, and operable to bias the clamp portion towards the second longitudinal side surface of the beam to clamp the accessory rail of the air gun between the clamp portion and the second longitudinal side surface of the beam;
a post extending from the beam in a direction substantially perpendicular to the longitudinal axis of the beam;
wherein the post defines a threaded bore extending along a bore axis in a direction substantially parallel to the longitudinal axis of the beam; and
a threaded rod disposed in threaded engagement with the threaded bore of the post, wherein the threaded rod includes a contact end disposed between the post and the first end of the beam, and wherein rotation of the threaded rod in a first rotational direction advances the contact end of the threaded rod toward the first end of the beam, and rotation of the threaded rod in a second rotational direction retracts the contact end of the threaded rod away from the first end of the beam.

25. A removable assembly aid for installing a power spring and a trigger assembly within a compression tube of an air gun, the removable assembly aid comprising:
a beam extending along a longitudinal axis between a first end and a second end;
wherein the beam includes a clamp portion disposed adjacent the first end of the beam, and operable to directly engage an accessory rail on the compression tube of the air gun in clamping engagement;
a compressor attached to the beam adjacent the second end of the beam and axially moveable along the longitudinal axis relative to the beam for compressing the power spring and moving the trigger assembly into position within the compression tube of the air gun; and
wherein the beam defines a slot extending along the longitudinal axis, with the slot defining a shape corresponding to the accessory rail on the compression tube of the air gun for interlocking engagement therebetween, wherein the interlocking engagement between the slot and the accessory rail prevents lateral movement of the beam relative to the air gun in a direction transverse to the longitudinal axis, and wherein the interlocking engagement between the slot and the accessory rail allows longitudinal movement of the beam relative to the air gun along the longitudinal axis.

26. The removable assembly aid set forth in claim 25 wherein the clamp portion and the beam are integrally formed together.

27. The removable assembly aid set forth in claim 25 wherein the beam includes a channel having a first portion extending from the first end of the beam axially along the longitudinal axis to an interior bend, and a second portion extending from the interior bend transverse relative to the longitudinal axis to a first longitudinal side surface of the beam, wherein the clamp portion is bounded by the first portion and the second portion of the channel.

28. The removable assembly aid set forth in claim 27 wherein the first portion of the channel separates the clamp portion from a second longitudinal side surface of the beam.

29. The removable assembly aid set forth in claim 28 further comprising a cross bore extending transverse to the longitudinal axis of the beam, wherein the cross bore includes a first section extending through the clamp portion and a second section extending through the second longitudinal side surface of the beam.

30. The removable assembly aid set forth in claim 29 further comprising a clamp screw extending through the first section of the cross bore and into threaded engagement with the second section of the cross bore, and operable to draw the clamp portion towards the second longitudinal side surface of the beam to clamp the accessory rail of the air gun between the clamp portion and the second longitudinal side surface of the beam.

31. The removable assembly aid set forth in claim 25 wherein the compressor includes a post extending from an upper longitudinal surface of the beam in a direction substantially perpendicular to the longitudinal axis of the beam.

32. The removable assembly aid set forth in claim 31 wherein the post defines a threaded bore extending along a bore axis in a direction substantially parallel to the longitudinal axis of the beam.

33. The removable assembly aid set forth in claim 32 wherein the compressor includes a threaded rod disposed in threaded engagement with the threaded bore of the post, wherein the threaded rod includes a contact end disposed between the post and the first end of the beam, and wherein rotation of the threaded rod in a first rotational direction advances the contact end of the threaded rod toward the first end of the beam, and rotation of the threaded rod in a second rotational direction retracts the contact end of the threaded rod away from the first end of the beam.
